(19) United States
(12) Patent Application Publication
(10) Pub. No.: US 2016/0047362 A1
(43) Pub. Date: Feb. 18, 2016

(54) Phase Change Device for Use within a Volume of Fluid

(71) Applicant: Ideal Innovations Incorporated, Arlington, VA (US)

(72) Inventors: Glen Dunham, Monrovia, MD (US); Loran Ambs, Williamsburg, VA (US)

(21) Appl. No.: 14/457,778

(22) Filed: Aug. 12, 2014

(51) Int. Cl. F03G 7/05; F03G 7/06

(52) U.S. Cl. CPC F03G 7/05; F03G 7/06

(57) ABSTRACT

A phase-change device for use in a volume of fluid, comprising a pressure vessel; a displacement cylinder; a displacement piston; a drive cylinder containing a phase-change material; a drive piston; and a gas spring. As the device sinks and experiences cooler fluid temperatures, the phase change material reduces in volume, causing the drive cylinder to move relative to the drive piston and thereby exert an outward force on the displacement piston. The displacement piston is pulled away from the displacement cylinder, increasing the overall displacement of the device. The increase in displacement increases the buoyancy of the device, thereby causing the device to rise in the fluid.

### CROSS-REFERENCE TO RELATED APPLICATION

Not applicable.

### BACKGROUND

There is widespread use of underwater sensor devices for tasks such as tsunami warning, navigation assistance, offshore exploration, oil and gas monitoring, and oceanographic research. For example, the US National Oceanic and Atmospheric Administration's Deep-Ocean Assessment and Reporting of Tsunamis (“DART”) system consists of 39 monitoring devices across the Pacific Ocean, Atlantic Ocean, and Caribbean Sea. This system takes pressure and temperature readings every 15 seconds at depths of up to 6000 meters, transmits those readings to surface buoys via acoustic modem, and relays the data to shore-based data centers through a satellite communications network. Each component in the system is powered by sets of 2,560 or 1,800 watt-hour alkaline batteries, which are sufficient to power the system for 2 years. See Christian Meinig, et al., Real-Time Deep-Ocean Tsunami Measuring, Monitoring, and Reporting System: The NOAA DART II Description and Disclosure, NOAA, Pacific Marine Environmental Laboratory (Jun. 4, 2005) (this publication is incorporated by reference).

A significant problem with current underwater devices, such as the DART system, is the relatively short operating duration because of limitations of power storage. Thousands of underwater sensor devices such as drifting buoys and electrically powered Autonomous Underwater Vehicles (“AUV(s)”) (e.g., the Slocum Glider) are lost every year when their power supplies expire. See Dan Stillman, Doing Their Part: Drifter Buoys Provide Ground Truth for Climate Data, Climat.gov (Jul. 25, 2014, 8:22 AM) [ ]www.climate.gov/news-features/climate-tech/doing-their-part-drifter-buoys-provide-ground-truth-climate-data, and Teledyne Webb Research, G2 Slocum Glider Autonomous Underwater Vehicle, Teledyne Webb Research Data Sheets (Jul. 25, 2014, 8:22 AM) [ ]www.webbresearch.com/pdf/Slocum_Glider_Data_Sheet.pdf. (both of these publications are incorporated by reference). These devices can range in cost from $10,000 to $100,000 each, representing a significant expenditure, especially when one takes into account the high cost of initial installation.

Recent approaches at providing longer lasting power for underwater devices have attempted to take advantage of the properties of a class of materials known as Phase Change Materials (“PCM(s)”). A PCM is a substance with a relatively high heat of fusion that is capable of storing and releasing significant amounts of energy when melting or solidifying. For a discussion on a wide variety of PCMs, see Atul Sharma et al., Review on Thermal Energy Storage With Phase Change Materials and Applications, 13 Renewable and Sustainable Energy Reviews 318 (2009), available at [ ]www.seas.upenn.edu/~meam502/project/reviewexample2.pdf (this publication is incorporated by reference).

PCMs have been used in underwater devices in conjunction with a hydraulic systems to change the overall device buoyancy. These devices take advantage of the expansion and contraction that takes place when the PCM passes through ocean temperature gradients. For example, US patent publication 8689556 B2 discloses a thermal generator wherein the expansion of the PCM indirectly actuates a hydraulic pump, which, via a control system and electrically actuated valves, transfers fluid into gas springs and an external bladder. This generator, when implemented in an underwater device, changes the volume of oil pumped to an external bladder. Changing the volume of the external bladder affects the buoyancy of the vessel and drives it to descend or ascend in the water column. Devices employing this technique however, still require an on-board electrical power source to power the valves and other elements of the control system. The requirement for this power source limits the applicability of this approach for long-range mobile underwater devices or remote sensing, and increases the risk of mechanical or electrical failure, as well as the cost of fabrication, fielding and maintenance.

Therefore what is needed is a device, which passively produces buoyancy changes in underwater devices and generates electricity without drawing upon an on-board power source.

### SUMMARY

A phase-change device for use in a volume of fluid, the device comprising: a pressure vessel; a displacement cylinder containing hydraulic fluid and rigidly affixed to the pressure vessel; a displacement piston movably situated within the displacement cylinder; a drive cylinder rigidly affixed to the displacement piston, the drive cylinder containing a phase change material, the drive cylinder having an inner surface and an outer surface, the drive cylinder having portions of the outer surface accessible to the fluid; a drive piston movably situated within the drive cylinder and rigidly affixed to the pressure vessel; and a gas spring operatively connected to the displacement cylinder.

### DESCRIPTION OF THE SEVERAL VIEWS OF THE DRAWINGS

FIG. 1 illustrates exemplary fluid environments in which embodiments of this disclosure may operate.

FIG. 2 depicts a cross sectional view of a device embodying aspects of this disclosure, depicting buoyancy generating components.

FIGS. 3a-3d depict a cross sectional view of a device embodying aspects of this disclosure, wherein the displacement aspects are emphasized.

FIG. 4 depicts a cross sectional view of a device embodying aspects of this disclosure, further depicting electricity generating components.

FIG. 5 depicts phase change data for the PCM hexadecane.

FIG. 6 depicts the volume change associated with the PCM hexadecane.

FIG. 7 depicts a device embodying aspects of this disclosure, wherein the PCM is situated within an oil bath.

FIG. 8. depicts a device embodying aspects of the disclosure, further depicting buoyancy arresting components.

FIGS. 9a-9c depict a device embodying aspects of this disclosure, further depicting several views of ambient fluid flow controlling components.

FIG. 10 depicts a device embodying aspects of this disclosure, further depicting an Integrated Power Generation System.

FIG. 11 depicts a device embodying aspects of this disclosure, further depicting the integration of power generating components with a sensor system.

FIG. 12 depicts a device embodying aspects of this disclosure, further depicting the integration of power generating components into underwater gliders.

FIG. 13 depicts a device embodying aspects of this disclosure, further depicting integration AUV power systems.

FIG. 14 depicts a device embodying aspects of this disclosure, further depicting integration into a drifting sensor buoy.

### DETAILED DESCRIPTION

This disclosure describes a PCM-based device that eliminates the need for a complex control system, associated valves, and the power they require to operate. This device may operate indefinitely without requiring any electrical power. The reduced complexity reduces the risk of mechanical or electrical failure, as well as the cost of fabrication, fielding and maintenance.

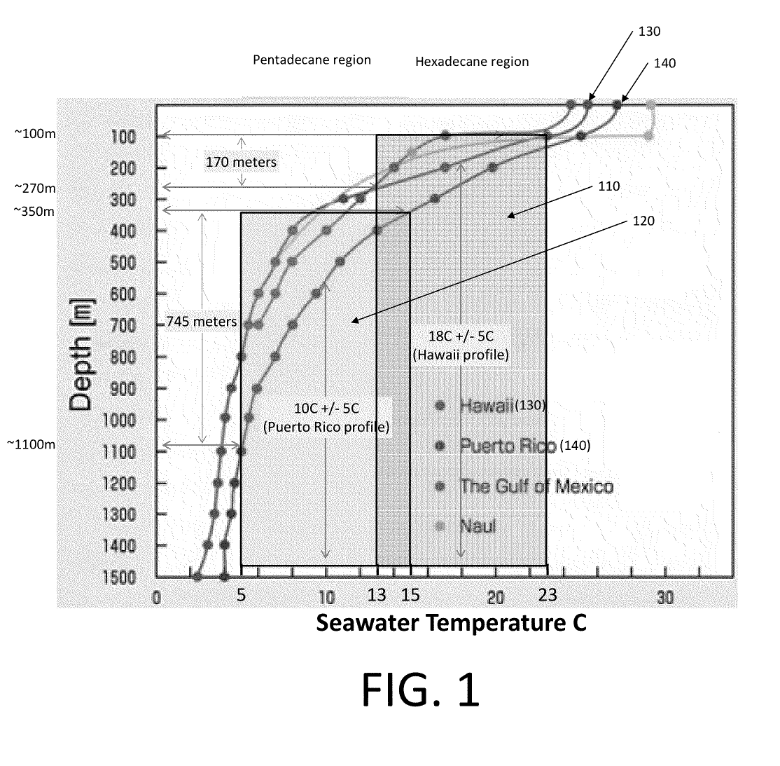

FIG. 1 illustrates exemplary fluid environments in which embodiments of this disclosure may operate. These fluid environments are specific ocean water temperature profiles selected from locations around the world. However any body of water having significant temperature or pressure variations will support operation of a device embodying aspects of this disclosure, and a person of ordinary skill in the art will recognize the full range of suitable types and volumes of fluids. FIG. 1 depicts a hexadecane region 110 and pentadecane region 120. Pentadecane and hexadecane are exemplary PCMs, which may be employed in embodiments of this disclosure. These PCMs are shown for illustration purposes only, and additional examples are discussed below.

The PCM regions depict the temperature range at which hexadecane and pentadecane, respectively, experience significant phase change and thereby significant expansion and contraction in volume. Therefor a device embodying aspects of this disclosure that employs hexadecane or pentadecane will operate substantially within the parameters defined by these regions. The Hawaii profile 130 and Puerto Rico profile 145 and depict how temperatures vary with depth in each body of water. The operational depths of the device for these specific bodies of water are shown by the overlap of the profile with the applicable PCM region. For example, if the device employs hexadecane and operates in the Hawaii water profile, its operation will span depths between about 100 m and about 270 m. Alternatively, if pentadecane were used in the Puerto Rican water profile, then its operation would span depths between about 350 m and about 1100 m.

As referenced above, the change in phase of a PCM from solid to liquid or vice versa produces a change in volume, sometimes exceeding 20%. PCMs can be selected based on a variety of factors, including temperature region, pressure region, depth, or geographic area of operation. N-alkanes exhibit atypically large volume expansion on melting and have selectable melting temperatures depending on the number of carbon atoms in the chain. For example, pentadecane, C₁₅H₃₂, melts at 10° C. and hexadecane, C₁₆H₃₄, melts at 18° C. For these reasons pentadecane is a PCM suitable for a deep diving device, and hexadecane is suitable for shallower submersions and higher temperatures. PCMs can be selected to match desirable operating depths and or other mission considerations. Constituent subcomponents of the device can be driven by different PCMs having characteristics that may extend the depth excursions of the combined device. PCMs can also be engineered to achieve desired performance characteristics, such as by mixing different materials or including non-PCM additives. Examples of PCMs suitable for this disclosure are shown in Table 1 below; however a person of ordinary skill in the art will recognize other PCMs suitable for devices embodying aspects of this disclosure.

TABLE 1

| | | | Liquid | | |
|---|---|---|---|---|---|
| | Chemical | Melting | density | Solid density | Phase change |
| Chemical formula | name | point (° C.) | (g/mL) | (g/mL) | density change |
| C₁₃H₂₈ | n-Tridecane | −5 | .756 | .854 | 13% |
| C₁₄H₃₀ | n-Tetradecane | 5 | .771 | .825 | 7% |
| C₁₅H₂₂ | n-Pentadecane | 10 | .769 | | |
| C₁₆H₃₄ | n-Hexadecane | 18 | .774 | .921 | 19% |
| C₁₇H₃₆ | n-Heptadecane | 22 | .777 | | |
| C₁₈H₃₈ | n-Octadecane | 28 | .774 | .814 | 5% |
| C₁₉H₄₀ | n-Nonadecane | 33 | .786 | | |
| CH₃(CH₂)8COOH | Capric acid | 32 | .886 | 1.004 | 13% |
| CH₃(CH₂)10COOH | Lauric acid | 43 | .870 | 1.007 | 16% |
| C₂₀H₄₂ | n-Eicosane | 36.4 | .780 | 815 | 4% |
| H₂0 | Water | 0 | .920 | 1000 | 7% |

An Exemplary Embodiment: Displacement

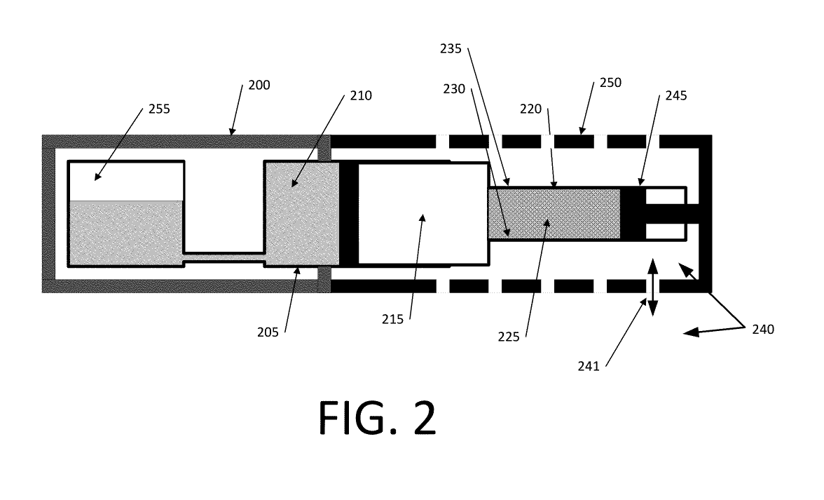

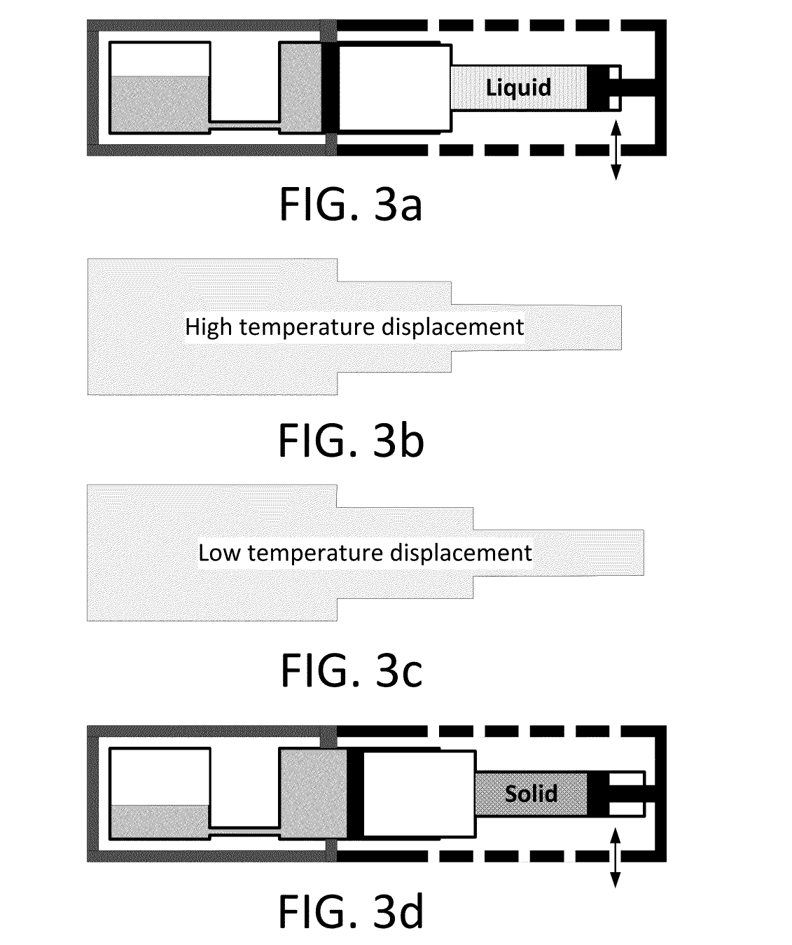

The following discussion illustrates the buoyancy generating aspects of this disclosure in reference to FIG. 2 and FIG. 3a-3d. FIG. 2 depicts a cross sectional view of a device embodying aspects of this disclosure, comprised of the following components: a pressure vessel 200; a displacement cylinder 205 containing a displacement substance (liquid or gas) 210 such as hydraulic fluid and rigidly affixed to the pressure vessel; a displacement piston 215 movably situated within the displacement cylinder; a drive cylinder 220 rigidly affixed to the displacement piston, the drive cylinder containing a PCM 225, the drive cylinder having an inner surface 230 and an outer surface 235, the drive cylinder having portions of the outer surface accessible to an environmental fluid 240 such as water via flow ports 241; a drive piston 245 movably situated within the drive cylinder and rigidly affixed to a drive piston frame 250, which is rigidly affixed to the pressure vessel; and a gas spring reservoir 255 operatively connected to the displacement cylinder. The change in volume of the PCM in the drive cylinder causes the drive cylinder to move in relation to the drive piston, which is rigidly connected to the displacement cylinder by rigid connections to the drive piston frame and the pressure vessel. Because the drive cylinder and displacement piston are rigidly connected, the force created by the change of phase of the PCM is imparted onto the displacement piston, which exerts pressure onto the displacement substance in the displacement cylinder, causing the displacement substance to be transferred to the gas spring reservoir. The pressure vessel, displacement cylinder, displacement piston, and drive cylinder form the outer boundary of the fluid-tight, enclosed volume of the device. The environmental fluid surrounds the remainder of the device and flows into the drive piston frame through the flow ports. The translation of the displacement piston into or out of the displacement cylinder changes the volume of environmental fluid displaced by the device and hence the density and buoyancy of the device.

The PCM in the device shown in FIG. 2 can be hexadecane and the displacement substance contained in the displacement cylinder can be hydraulic fluid. Hexadecane is a solid at temperatures below 18° C. and a liquid at temperatures above 18° C. The change in phase from solid to liquid or vice versa produces a change in density of the PCM which results in a change in volume of about 20%. When appropriately ballasted the device is negatively buoyant in water at temperatures above 18° C. The device will sink through a water column with temperatures that decrease with depth. At temperatures 18° C. and cooler, the temperature responsive PCM will solidify, which reduces its volume and pulls the displacement piston out of the displacement cylinder and thus increases overall displacement. This makes the device more buoyant whereupon the system will begin to rise through the water column. As it rises, warmer water flows through the flow ports in the drive piston frame. This warmer water causes the PCM to melt, which increases its volume in the PCM cylinder. This results in the displacement piston being pushed into the displacement cylinder and thereby a reduction of overall displacement and a reduction in buoyancy. The device continues to oscillate between warm and cold water depths, being powered by the temperature differences in the water column. The depth at which the device reaches neutral buoyancy can be adjusted by controlling the rate of heat transfer across the drive cylinder-water interface. The fluid environment, of course, has an impact on the displacement characteristics of the device. For example, if one assumes the device becomes neutrally buoyant at a temperature of 5° C. below the freezing point of the PCM, then according to the chart in FIG. 1 the device would be at a depth of about 280 m for a location in waters offshore Hawaii.

FIGS. 3a-3d further illustrate to the buoyancy aspects of the device discussed in reference to FIG. 2. FIG. 3a depicts the device operating in fluid temperatures above 18° C. At this temperature hexadecane is in its high volume, liquid phase and nearly fills drive cylinder. The diameter of the displacement piston and displacement cylinder may be larger than the drive cylinder in order to amplify the quantity of hydraulic fluid transferred by the volume change of the hexadecane. Pressure in the drive cylinder created by the phase change of hexadecane can be on the order of 1000 (s)lbs/in².

FIG. 3d depicts the device in the opposite state as that shown in FIG. 3a. FIG. 3d depicts the device operating in fluid temperatures below 18° C. At these temperatures hexadecane is in its low volume, solid phase, significantly pulling the displacement piston out of the displacement cylinder and increasing the overall displaced volume of the device.

FIGS. 3b and 3c show the relative differences in displacement between the two states of the device. Each of these views depict only the enclosed, fluid-tight volume of the device, comprising the pressure vessel, displacement cylinder, displacement piston, and the drive cylinder. FIG. 3b emphasizes the relatively smaller displacement of the device in the liquid-phase state of FIG. 3a, as compared to FIG. 3c, which emphasizes the larger displacement of the device in the solid-phase state of FIG. 3d.

An Exemplary Embodiment: Power Generation

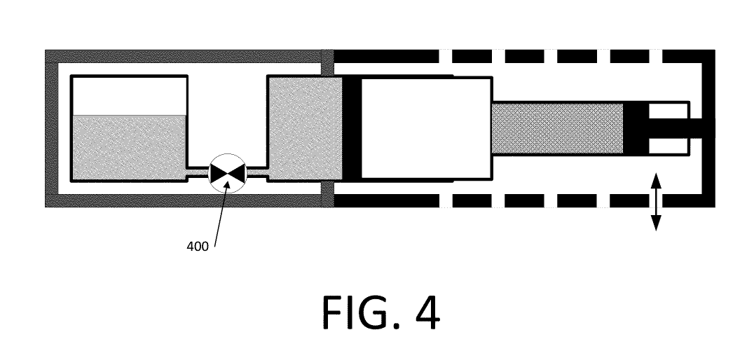

The following discussion is in reference to FIG. 4 and illustrates the power generating aspects of this disclosure. FIG. 4 depicts a cross sectional view of a device embodying aspects of this disclosure, comprised of the following components: a pressure vessel; a displacement cylinder containing a displacement substance (liquid or gas) such as hydraulic fluid and rigidly affixed to the pressure vessel; a displacement piston movably situated within the displacement cylinder; a drive cylinder rigidly affixed to the displacement piston, the drive cylinder containing a PCM, the drive cylinder having an inner surface and an outer surface, the drive cylinder having portions of the outer surface accessible to an environmental fluid such as water via flow ports; a drive piston movably situated within the drive cylinder and rigidly affixed to a drive piston frame, which is rigidly affixed to the pressure vessel; a gas spring reservoir operatively connected to the displacement cylinder; and an electric generator 400 (such as a hydraulic generator, pneumatic generator, or a linear electric generator), operatively connected to the displacement cylinder and the gas spring reservoir. The force created by the change of phase of the PCM is imparted onto the displacement piston, which exerts pressure onto the displacement substance in the displacement cylinder, causing the displacement substance to be transferred to the gas spring reservoir. The displacement substance imparts pressure on the electric generator as it travels from the displacement cylinder to the gas spring reservoir. The pressure of the displacement substance causes the electric generator to operate and thereby generate electricity. For example, if the displacement substance was hydraulic fluid or a gas, then electricity would be generated by a hydraulic generator or pneumatic generator, respectively. As a result of this process electricity is available for a variety of applications.

Calculations

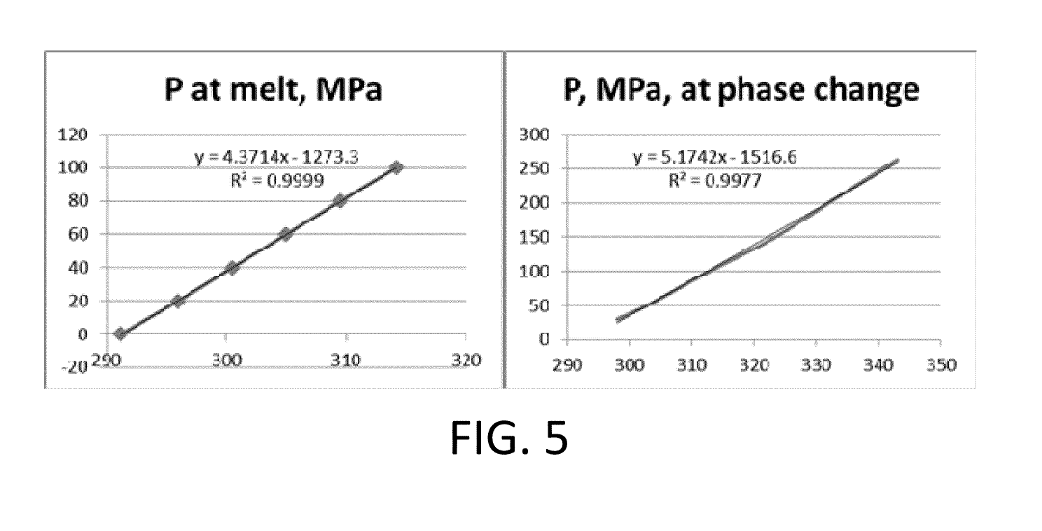

The following discussion in reference to FIGS. 5-7 provide exemplary calculations of operational parameters of this disclosure. A person having ordinary skill in the art will recognize alternative parameters suitable for devices embodying aspects of this disclosure.

PCM

As mentioned above, hexadecane is a useful PCM for ocean-going applications. The petroleum industry has historically shown scientific interest in hexadecane, and has sought to optimize its extraction from terrestrial strata. Several authors have published differential thermal analyses, which relate pressure, volume, and temperature. For example Melhet et al. discusses an analysis of tetradecane+pentadecane systems and tetradecane+hexadecane systems, and Wurflinger and Sandmann discusses a similar analysis of n-hexadecane and n-heptadecane. See Milhet, et al, Liquid-Solid Equilibria under High Pressure of Tetradecane+Pentadecane and Tetradecane+Hexadecane Binary Systems, Fluid Phase Equilibria 235 (2005) 173-181 and Wurflinger and Sandmann, Thermodynamic Measurements on N-hexadecane and N-heptadecane at Elevated Pressures, Z. Naturforsch 55a (2000) 533-538 (These publications are incorporated by reference into this specification). FIG. 5 depicts the data for hexadecane resulting from these studies, with equations for linear fit. The abscissa is temperature in kelvin and the ordinate is pressure in MPa. Calculating pressure (from the linear equations) generated by melting at 23° C. (296K) yields 21 MPa from the left plot and 15 MPa from the right plot. Averaging these and converting to lbs/in² yields 2650 lbs/in² during melting. For the purposes of convenience, a pressure value of 2500 lbs/in² will be used for the calculations discussed in below.

Volume

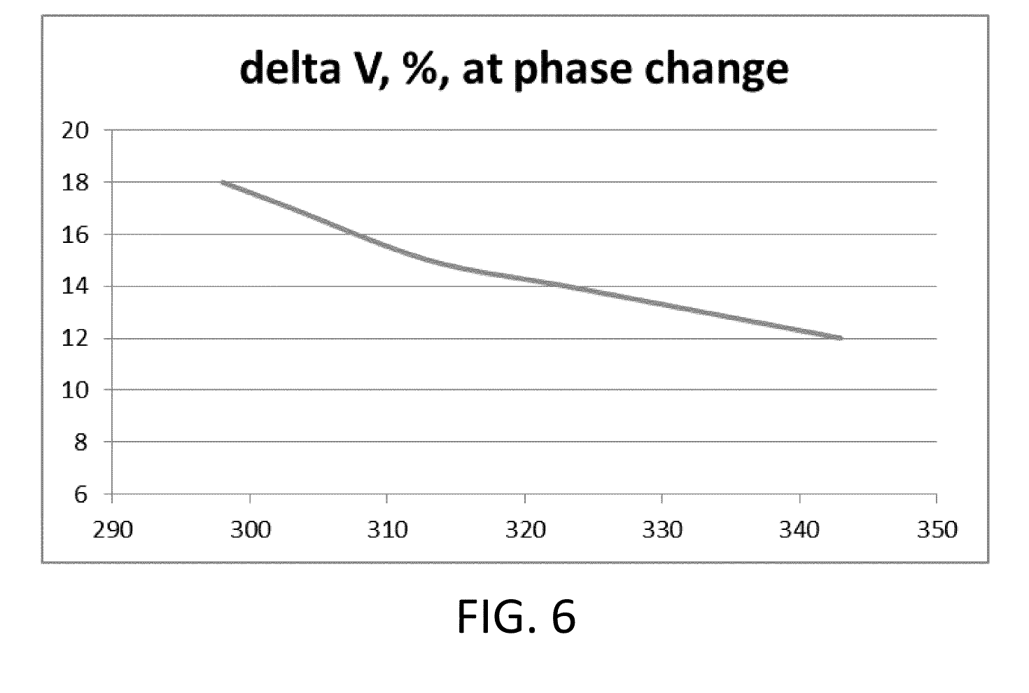

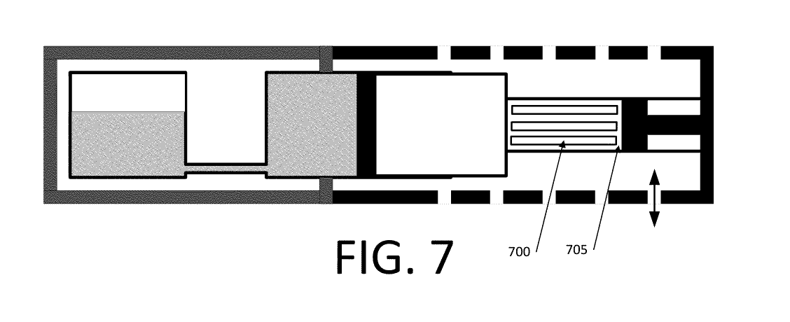

FIG. 6 is a chart the volume change associated with hexadecane phase change as discussed in Wurflinger and Sandmann. The volume change at 23° C. is about 19%. Employing substantially pure hexadecane provides excellent thermodynamic performance. However, often it is also advantageous to encapsulate certain PCMs in an oil bath. PCMs in solid phase can bond to the drive piston and drive cylinder and interfere with their operation. The oil acts as a lubricant to prevent excessive binding of the PCM to cylinder walls. FIG. 7 depicts a device embodying aspects of this disclosure, wherein the PCM is situated within an oil bath. In this embodiment the PCM is broken up into segments sealed in flexible tubes 700. These tubes can then be immersed in an oil bath 705 within the drive cylinder. In this way the PCM is protected from the potentially harmful effects of certain lubricants, while still maintaining flexibility to expand and contract. An alternative to encapsulating the PCM is to use commercially available macrospheres, such as those manufactured by Microtek Laboratories. Such spheres are approximately 4 mm in diameter, have a density of approximately 1 g/cm³, and are comprised of a polymer matrix encapsulating 80% of the sphere's volume with PCM. These spheres have a reasonably high packing density. The highest density close packing of equal spheres is 0.74. Random close packing achieves a density between 0.60 and 0.64. For the purposes of this disclosure and for numerical convenience, 0.61 will be used for the packing density, since multiplied by the hexadecane composition in each sphere, the volume fraction of hexadecane is 0.50.

Pressure

A device embodying aspects of this disclosure experiences varying ambient pressure from the water column as it descends and ascends. In electricity generating variants, the effect is a reduction of the pressure differential across the electric generator and therefore, a reduction of available energy. If one assumes a 5:1 ratio between the cross-sectional area of the displacement cylinder and the cross-sectional area of the drive cylinder, the displacement cylinder will exert 20% of the pressure of the drive cylinder, while displacing 5 times the volume. Thus the melted hexadecane exerts 2500 lbs/in² pressure, and its pressure on a displacement substance is 500 lbs/in². If the device is working in an ocean environment, the water exerts an additional 150 lbs/in² on the surface of the displacement cylinder. Therefore, the ultimate pressure of the gas spring is 650 lbs/in². When placed in colder water the hexadecane freezes and contracts, allowing the gas spring to push the displacement cylinder the right against the higher pressure at the greater depth. Therefore, the final minimum pressure in the gas spring is 450 lbs/in². This results in an average pressure differential available to the electric generator during expansion and contraction of:

$$\frac{650 lbs \text{/} {in}^{2} - 450 lbs \text{/} {in}^{2}}{2} = 100 lbs \text{/} {in}^{2}$$

Energy

The following calculations demonstrate the energy generated per expansion and contraction cycle for “large” and “small” variants of the device. Based on the application, a person of ordinary skill in the art will recognize suitable variations on the parameters suggested in order to optimize energy generation in consideration of the water column pressure and the pressure needed to operate electric generator.

For a “large” device, one may assume the above referenced 5:1 ratio between cross-sectional areas of the displacement cylinder and the drive cylinder. In this variant the Inside Diameter (“ID”) of the drive cylinder is 8 cm, the area of the drive cylinder is 50 cm², the ID of the displacement cylinder is 17.6 cm, and the area of the displacement cylinder is 250 cm². The drive cylinder diameter is small in order to enhance thermal conduction. A person of ordinary skill in the art will recognize additional features that improve thermal conduction such as metal fins. The drive cylinder carries a volume of 26.4 L and contains 13.2 L of hexadecane, which expands to 15.7 L when melted. The change in volume of 2.5 L translates the displacement cylinder 50 cm. Therefore the available energy at the displacement cylinder is as follows:

$$W = f * d = 100 lbs \text{/} {in}^{2} * 250 {cm}^{2} * 50.0 cm$$

$$1.00 lbs \text{/} {in}^{2} = 0.69 n \text{/} {cm}^{2} \\ \to 100 lbs \text{/} {in}^{2} * \frac{0.59 n \text{/} {cm}^{2}}{1.00 lbs \text{/} {in}^{2}} * 250 {cm}^{2} * 50.0 cm = 8.60 * {10}^{5} ncm = 8.60 * {10}^{3} nm \\ \to W = 8.60 * {10}^{3} J ( which must be doubled to include expansion and contraction ) \\ \to {W}_{c} = ( 8.60 * {10}^{3} J ) * 2 = 1.70 * {10}^{4} J \\ ( where {W}_{c} is the energy available in one cycle )$$

A “small” device, 1/50^{th} the scale of the large device, produces about 0.25 watts continuously. In this variant the ID of the drive cylinder is 2 cm, the area of the drive cylinder is 12 cm², the ID of the displacement cylinder is 8.8 cm, and the area of the displacement cylinder is 60 cm². The drive cylinder carries a volume of 0.5 L and translates the cylinder 4 cm. In accordance with the above calculation, these parameters result in an energy value per cycle of 3.4*10²J.

Power

Power calculations for both the large and small variants assumes a cycle from 100 m below sea surface to 300 m below surface. Therefore, the device travels 400 m in one cycle. The speed is assumed to be 0.4 m/s, for a cycle time, t_{c}, of 1000 s. Thus the total power is:

$$P = {W}_{c} / {t}_{c} = \frac{1.74 * {10}^{4} J}{1000 s} = 17.0 watts ( for the large device )$$

$$P = {W}_{c} / {t}_{c} = \frac{3.40 * {10}^{2} J}{1000 s} = 0.30 watts ( for the small device )$$

Electrical Conversion

A person of ordinary skill in the art will recognize a range of electric generators suitable to convert the mechanical energy generated by the device into electrical energy. In some circumstances it may be advantageous to employ a hydraulic generator, pneumatic generator, or linear electric generator. For example, the device may operate pneumatically on the drive side, such that the displacement substance is nitrogen and the electric generator is a pneumatic generator. Love, et al. demonstrates that the typical optimized system efficiency for conversion from electric power to fluid power is 75%. Love, et al., Estimating the impact (energy, emission and economics) of the US fluid power industry, Report to US Department of Energy by Oak Ridge National Laboratory and the National Fluid Power Association (December 2012) available at [ ]news.nfpahub.com/fluid-powers-role-nations-energy-efficient-future-part-3-determining-energy-consumption-fluid-power-systems/ (this publication is hereby incorporated by reference). For the purposes of this disclosure we assume the same efficiency for the converse conversion. Therefore, the electrical energy, E_{c}, produced per cycle is as follows:

E_{c}=1.74*10⁴J*0.75=1.30*10⁴J (for the large device)

E_{c}=3.40*10²J*0.75=2.60*10²J (for the small device)

and the power, calculated on a continuous basis, is:

P=13.0 watts (for the large device)

P=0.26 watts (for the small device)

Electrical Storage and Transmission

To minimize maintenance requirements the electrical energy is stored each cycle in a super capacitor (although a standard battery may also be suitable for certain applications). Super capacitors are advantageous because their self-discharge half-life is measured in weeks. A 350 g lithium-ion super capacitor will accept 1.9*10⁴J at 2.5 volts for millions of charge/discharge cycles. For larger devices, a larger super capacitor array able to store 1.8*10⁴ kJ (5 kwh) is appropriate.

Buoyancy

The magnitude of the displacement change in response to PCM volume change depends principally upon the volume of PCM in the drive cylinder, the diameter of drive cylinder, and the diameter of the displacement cylinder. The volume displaced by the PCM-driven buoyancy system dictates how large of a device (gross displacement) is supported. Other factors affecting the device are the rate of heat exchange and the speed of the system moving through the water column. A person of ordinary skill in the art will recognize optimal combinations of these variables to produce the motive forces necessary to continuously traverse the temperature gradient and generate power for a particular application. Given the assumptions presented in the power calculations above, the overall displacement is about 1045 kg for large devices and about 100 kg for small devices.

Additional Exemplary Embodiments

The following discussion describes additional exemplary devices embodying aspects of this disclosure, and variations thereof.

Arrested Buoyancy

The buoyancy of a device embodying aspects of this disclosure can be fixed at a set value so that the buoyancy will not change even though the temperature of the surrounding fluid changes. Although the device will not change depth, it will continue to capture energy from the natural variations fluid temperature. This embodiment is advantageous for applications where buoyancy changes interfere with the operation of the device.

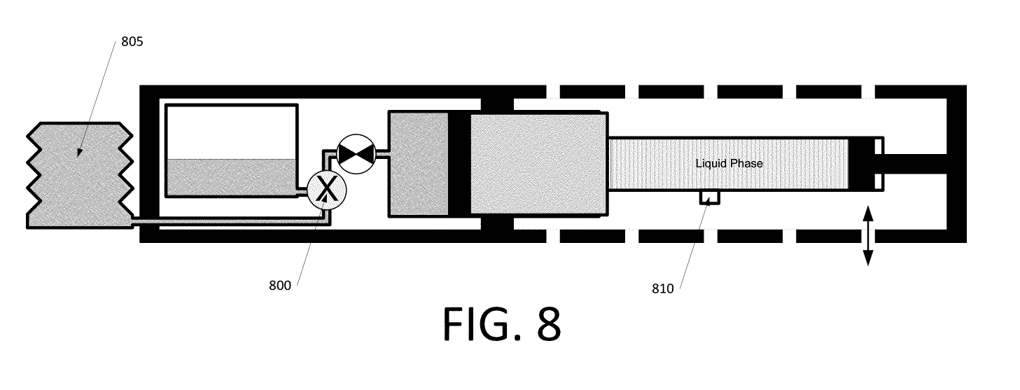

FIG. 8. illustrates examples of additional components employed to arrest changes in buoyancy. A valve 800 is added to the device, which diverts the displacement substance from the gas-spring reservoir to an expandable bladder 805 external to the pressure vessel. Temperature induced displacement of the displacement piston, which would normally change the buoyancy of the device, is exactly balanced by an opposite change in the external expandable bladder. The buoyancy state of the device may be established using a position sensor 810 on the drive cylinder or displacement piston previously calibrated. Arresting buoyancy changes when the device is neutrally buoyant is desirable for a drifting buoy positioned at a particular depth. Arrested buoyancy when neutral at a particular depth is also useful if the device is integrated within an AUV to prevent the AUV from interfering with controlled depth changes. Restarting the arrested device requires returning it to equilibrium conditions at temperatures above the PCM freezing point and returning the flow of the displacement substance to the internal gas spring. When released, the device will again oscillate between warm and cold water depths and generate electricity.

Modified Mass Transport of Heat

Controlling the access of environmental fluid, such as ocean water, to the drive cylinder will accelerate or retard the change of phase of the PCM. Improving the flow of water across the drive cylinder will improve the transfer of heat and thus reduce the time required to change the PCM from one state or another. Restricting the flow of water across the drive cylinder will reduce the rate of heat transfer and prolong the time it takes to change PCM from one phase to another when exposed to temperature differences. Enhancing or restricting flow may be changed dynamically to improve heat transfer at some points of descent or ascent and restrict it at others.

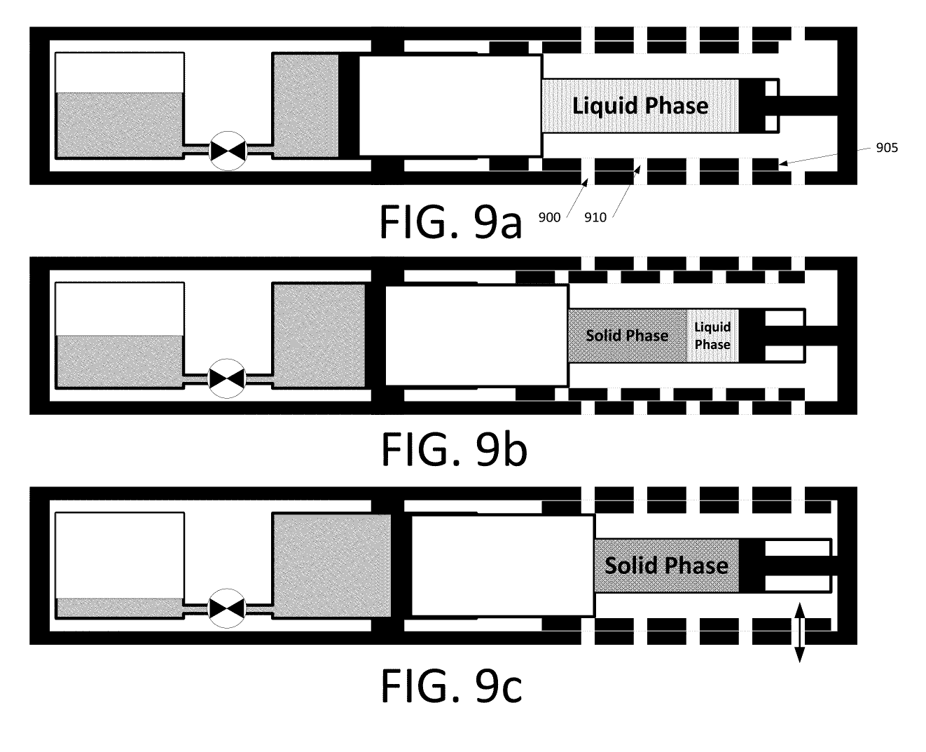

FIGS. 9a-9c illustrate several views of a device embodying aspects of this disclosure, which controls the flow of ambient water across the drive cylinder. In this embodiment, the drive piston frame is perforated by a number of flow ports 900. A gate assembly 905 is perforated with a number of flow gates 910. The gate assembly is rigidly affixed to the displacement piston so that the gate assembly moves in unison with the displacement piston. In this embodiment, the flow gates and the flow ports are aligned when all of the PCM is one phase or the other. FIG. 9a depicts the extreme liquid phase of the device. In this configuration all flow gates and flow ports are completely aligned, allowing maximum heat transfer from the PCM. In FIG. 9c the extreme solid phase is depicted. The flow port and flow gate configuration is the same as in FIG. 9a because this configuration maximizes heat transfer to the PCM. When the device is neutrally buoyant as in FIG. 9b, the flow gates and flow ports are misaligned and heat transfer is restricted. Depending upon the desired characteristics of the power generation cycles, the ports and gates could are selectively aligned or misaligned.

Other means of improving or limiting heat flow into or around the PCM-filled drive cylinder can be employed to achieve desired characteristics of device oscillation. Heat flow can be restricted by insulating portions of the drive cylinder. For example, the displacement piston can envelop the drive cylinder to provide insulating effects. Heat-transfer fins or heat-tubes can be employed to assist heat transfer between the ambient water and the drive cylinder. Additionally, active means of heating or cooling the drive cylinder, such as by employing Peltier heaters/coolers to produce the desirable effect.

Encapsulated PCM

As mentioned above in reference to FIG. 7, employing hexadecane as a liquid directly filling a displacement cylinder would optimize thermodynamic performance but may cause problems with the solid phase interfering with the operation of the drive piston and drive cylinder. To avoid this potential problem, PCM may be encapsulated in envelops of a flexible material (rubber, metal, plastic) on any suitable length, width, height or cross sectional shape (e.g., rectangular, circular, star) to facilitate deformation in response to volume changes resulting from changes in the phase of the PCM. Some shapes (i.e., star) are more compliant than others (i.e., circular). The encapsulated PCM elements may be any size. Some could be rigidly mounted in the drive cylinder or dispersed in the displacement fluid. In the alternative, an embodiment may employ commercially available macrospheres containing a PCM. These could be held behind a screen in the drive cylinder to ensure they do not interfere with relative motion between the drive cylinder and the drive piston.

AUV Charging Station

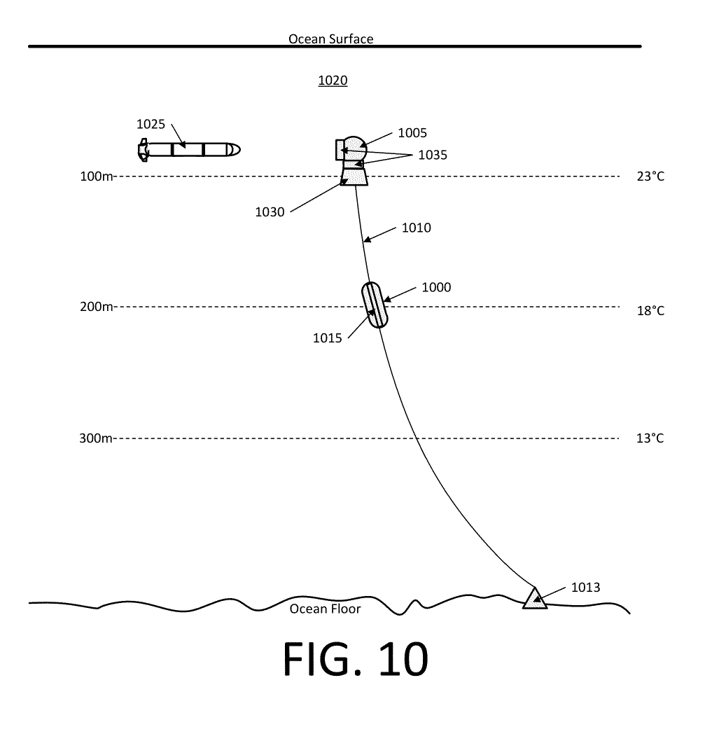

FIG. 10 depicts a device embodying aspects of this disclosure, wherein a Power Generating Component (“PGC”) 1000 is combined with a subsurface buoy 1005 anchored to the ocean floor by guideline 1010 and anchor 1013. The PGC is a device substantially similar in operation to the device described in the above exemplary embodiments. The PGC is attached to the guideline by a guide structure 1015, such as a pulley or eye loop. The PGC travels freely through varying depths but is otherwise restricted in movement by the guideline. Combined, this set of components make up an Integrated Power Generating System (IPGS) 1020. In this embodiment, the IPGS is used as a charging station for an electrically powered AUV 1025.

As the PGC ascends and descends the guideline it generates electricity and stores it onboard in a battery or super capacitor as described above. The power generated by the PGC as it traverses the guideline is stored as direct current (“DC”). As the PGC approaches the subsurface buoy, its velocity is slowed by a fluid-based deceleration chamber 1030, such as an open ended cylinder with fluid release ports. Ultimately, the PGC comes to rest and the electric power stored onboard the PGC is transferred inductively to a larger capacity storage system onboard the subsurface buoy by means of a power exchange interface 1035, such as the “Mange Charge” inductive charging system developed by General Motors. When the PGC is in very close proximity to the power exchange interface, a set of electric coils in the power exchange interface of the subsurface buoy couples electromagnetically with a similar set of coils in the PGC and inductively transfers power from the PGC to the subsurface buoy. DC electric power on PGC is converted to Alternating Current (“AC”) via a converter on the PGC. The resulting alternating magnetic field produces AC in the power exchange interface coils of the subsurface buoy, which is converted back into DC for storage in batteries or super-capacitor onboard the subsurface buoy. A person of ordinary skill in the art will recognize the range of applicable means for AC/DC conversion. In this way the power generated by each descent and ascent of the PGC is transferred to the larger storage capacity of the subsurface buoy. The power stored onboard subsurface buoy is available for the electrically powered AUV. The approaching AUV receives power form the buoy through a second power exchange interface in the same manner as the buoy receives power from the PGC as described above.

Drifting Sensor Buoy

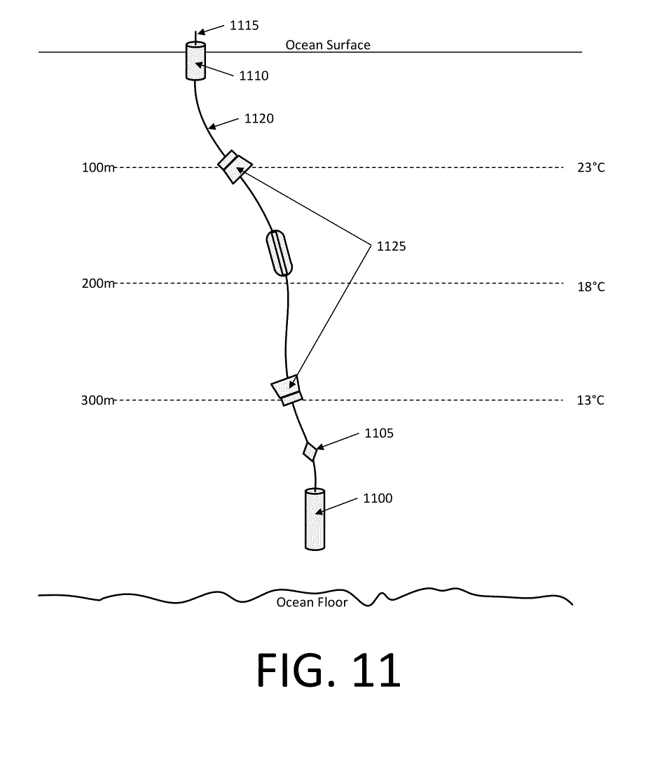

FIG. 11 depicts a device embodying aspects of this disclosure, wherein an IPGS as described in reference to FIG. 10 is employed to provide power is integrated with sensor system. The sensor system is composed of a sensor 1100, a sensor processing system 1105, and a surface buoy 1110 outfitted with a wireless communication component 1115, such as an RF transponder. The surface buoy is attached to the sensor by a tether conduit 1120, which contains a strength member, a power cable, and one or more telemetry cables such as wire or optical fiber. A PGC 910 is movably employed along the conduit in the same manner as the guideline described above with respect to FIG. 9. Power exchange interfaces 1125 are attached to the conduit at the upper and lower limit of the travel. Power is exchanged in a similar manner as the IPGS described above in reference to FIG. 10. Generated power is transmitted along the power cable to the sensor, sensor processing system, and surface buoy. Any or all of these components may convert and store generated power and redistribute excess power as is necessary. A person of ordinary skill in the art will recognize the range of suitable means to store and redistribute power, such as an automated power management system.

Undersea Glider

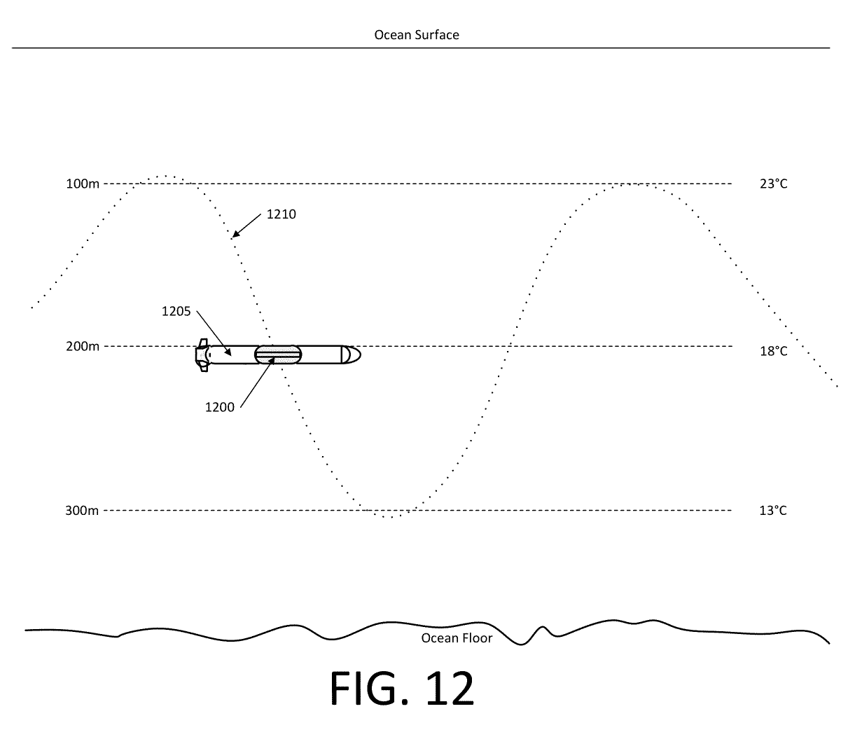

FIG. 12 depicts a device embodying aspects of this disclosure, wherein a PGC 1200 is integrated into an underwater glider 1205 such as the Slocum Glider referenced above. The wings of the glider convert vertical changes in position within the water column into horizontal changes in position. As the glider descends or ascends along path 1210 it is translated laterally. Cyclic changes in buoyancy of the PGC as it traverses the water column within its operating temperature ranges provide the motive forces to propel the glider. The PGC may also provide power for ancillary systems such as data processing and communication. The control system of the glider and its organic ballasting system may be used to override the PGC dynamic ballasting to ascend to the surface. Communication may be accomplished by acoustic or RF means or other convenient means suitable for it mission.

On-Board AUV Recharging

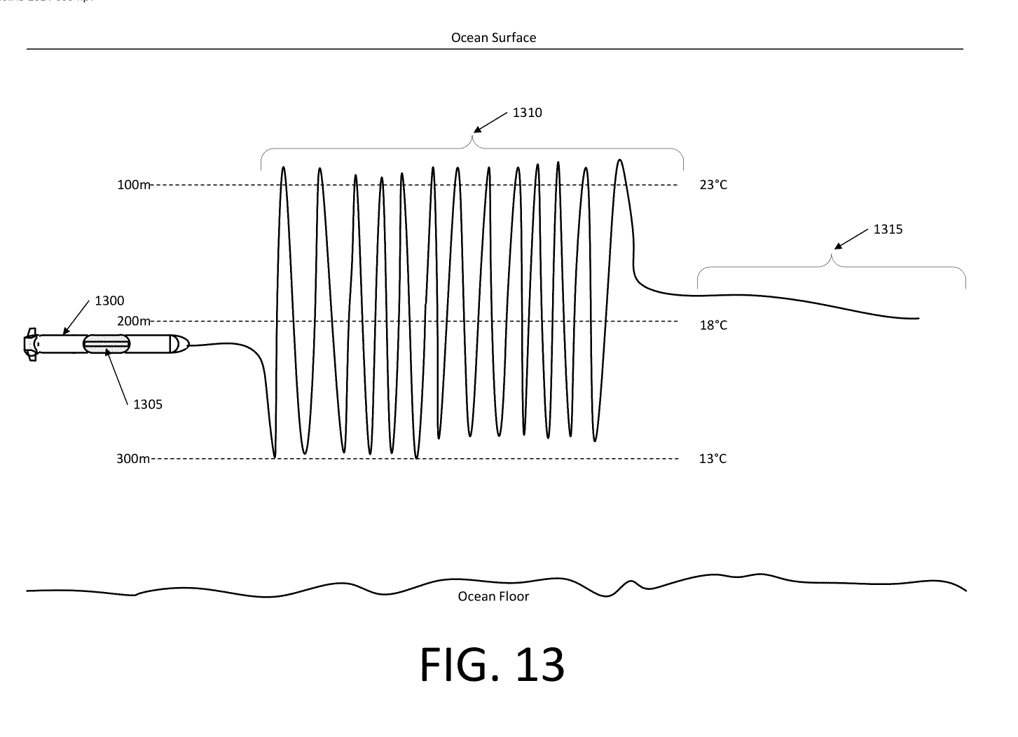

FIG. 13 depicts a device embodying aspects of this disclosure, wherein a PGC is employed within an actively propelled AUV 1300 such as the “Remus” line of vehicles developed by the Woods Hole Oceanographic Institution, Oceanographic Systems Laboratory or the “Bluefin” line of vehicles developed by Bluefin Robotics. In these embodiments the electric generator of the PGC 1305 is operatively connected to the power system of the AUV. During times in which the AUV is actively propelled, the PGC will be configured to be neutrally buoyant for the operating depth convenient for the AUV and have dynamic buoyancy arrested. When the power management system of the AUV determines that the batteries of the AUV power system are in need of recharging, the AUV will travel to an appropriate depth to restart dynamic buoyancy of the PGC and unlock dynamic buoyancy. In this mode the AUV ceases active propulsion and acts under the ballast control of the PGC as it traces a cyclic path 1310 with the temperature ranges of the PGC. When power management system of the AUV indicates sufficient replenishment of power has occurred, the ballast of the PGC is returned to a neutral position and dynamic buoyancy of the PGC is again arrested. The AUV then continues along a transit path 1315 appropriate for its mission. The device may hibernate for periods of time between missions in a recharging mode and occasionally ascend to the surface to exchange information.

Drifting Profiler

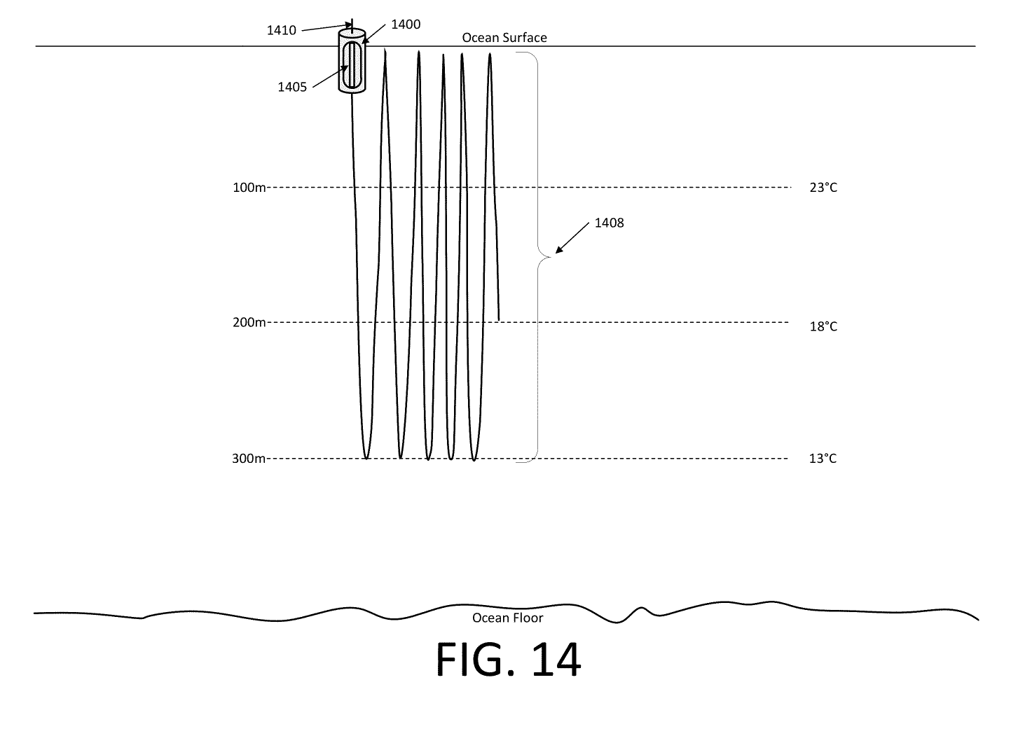

FIG. 14 depicts a device embodying aspects of this disclosure, wherein a drifting profiler sensor buoy 1400 is integrated with a PGC 1405 to provide power for collecting, processing, and communicating data. In this embodiment, in addition to power generation, the PGC provides the changes in buoyancy necessary for a profiler to traverse the water column 1408 to collect data from many depths as it drifts with the ocean current. The ballasting of the profiler is adjusted to ensure that the profiler ascends to the surface to communicate at the peak of each cycle. Alternatively the device may have a separately controlled buoyancy system to actively surface the buoy intermittently for data. Communication may be accomplished by acoustic or RF transmitter 1410 or other convenient means suitable for it mission. In order to facilitate emergency recovery, a drop weight can be employed which may be electrically, mechanically, or electromechanically released, causing the device to propel to the surface. A depth sensor may signal the control system to trigger release the drop weight at a prescribed depth. Alternatively, a release trigger could be actuated by a compressible junction (e.g., bellows) when a prescribed depth is exceeded. This type of mechanical trigger has the advantage of operating even if on-board electronic control is inoperative.

Conclusion

Although the embodiments of this disclosure may be incorporated without departing from the scope of the following claims, it will be apparent to those of ordinary skill in the art that numerous variations can be made. Other embodiments will be apparent to those of ordinary skill in the art from consideration of the specifications and drawings of this disclosure. It is intended that the specification and examples be considered as exemplary only, with a true scope being indicated by the following claims and their equivalents.

1. A phase-change device, comprising:
a pressure vessel;
a displacement cylinder rigidly affixed to the pressure vessel;
a displacement piston movably situated within the displacement cylinder;
a drive cylinder rigidly affixed to the displacement piston, the drive cylinder containing a phase-change material, the drive cylinder having an inner surface and an outer surface, the drive cylinder having portions of the outer surface accessible to the fluid;
a drive piston movably situated within the drive cylinder and rigidly affixed to the pressure vessel; and
a gas spring operatively connected to the displacement cylinder.

2. The device of claim 1, further comprising a flow controller, comprising:
a drive piston frame having one or more flow ports; and
a gate assembly rigidly affixed to the displacement piston and having one or more flow gates.

3. The device of claim 1, further comprising arrested buoyancy components, comprising:
an expandable bladder located at least partially outside of the pressure vessel;
a first connector, operatively connected between the displacement cylinder and the gas spring;
a second connector, operatively connected between the first connector and the expandable bladder; and
a valve operatively connected to the second hydraulic connector.

4. The device of claim 1, further comprising an envelope encapsulating the phase-change material.

5. The device of claim 1, further comprising an envelope encapsulating the phase-change material and wherein the envelope is situated in a fluid contained in the drive cylinder.

6. The device of claim 1, wherein the phase-change material is predominantly responsive to temperature variation.

7. The device of claim 1, wherein the displacement cylinder contains hydraulic fluid.

8. A phase-change power generator for use in a volume of fluid, the generator comprising:
a pressure vessel;
a displacement cylinder rigidly affixed to the pressure vessel;
a displacement piston movably situated within the displacement cylinder;
a drive cylinder rigidly affixed to the displacement piston, the drive cylinder containing a phase-change material, the drive cylinder having an inner surface and an outer surface, the drive cylinder having portions of the outer surface accessible to the fluid;
a drive piston movably situated within the drive cylinder and rigidly affixed to the pressure vessel;
a gas spring operatively connected to the displacement cylinder; and
an electricity generating motor operatively connected to the displacement cylinder and the gas spring.

9. The generator of claim 8, wherein the phase-change material is predominantly responsive to temperature variation.

10. The generator of claim 8, wherein the displacement cylinder contains hydraulic fluid.

11. The generator of claim 8, wherein the electricity generating motor is powered by pneumatic pressure.

12. The generator of claim 8, further comprising an underwater vehicle, wherein the generator is housed within the vehicle.

13. The generator of claim 8, further comprising an underwater vehicle, comprising a propulsion system, wherein the generator is housed within the vehicle and operatively connected to the propulsion system.

14. A phase-change power generation buoy, comprising:
a buoy having a top and a bottom;
a guideline connected to the bottom of the buoy; and
a guideline channel affixed to a generator and configured to enable the generator to move freely along the guideline, the generator comprising:
a pressure vessel;
a displacement cylinder containing hydraulic fluid and rigidly affixed to the pressure vessel;
a displacement piston movably situated within the displacement cylinder;
a drive cylinder rigidly affixed to the displacement piston, the drive cylinder containing a phase-change material, the drive cylinder having an inner surface and an outer surface, the drive cylinder having portions of the outer surface accessible to the fluid;
a drive piston movably situated within the drive cylinder and rigidly affixed to the pressure vessel;
a gas spring operatively connected to the displacement cylinder; and
an electricity generating motor operatively connected to the displacement cylinder and the gas spring;

15. The buoy of claim 14, wherein the phase-change material is predominantly responsive to temperature variation.

16. The buoy of claim 14, wherein the displacement cylinder contains hydraulic fluid.

17. The buoy of claim 14, wherein the electricity generating motor is powered by pneumatic pressure.

18. The buoy of claim 14, further comprising a sensor system, wherein the guideline contains an electricity transmission line operatively connecting the buoy and the sensor system, and wherein the buoy further comprises a power exchange interface.

19. The buoy of claim 14, wherein the guideline is anchored at an ocean floor location.

20. The buoy of claim 14, wherein the buoy is configured such that it is a subsurface buoy.
